(19) United States
(12) Patent Application Publication
(10) Pub. No.: US 2013/0228234 A1
(43) Pub. Date: Sep. 5, 2013

(54) TAP STAND AND LIQUID DELIVERY SYSTEM

(71) Applicant: FAST ENGINEERING LIMITED, Antrim (GB)

(72) Inventors: Seamus Connolly, Belfast (GB); Fiona Bennington, Belfast (GB)

(73) Assignee: Fast Engineering Limited, Antrim (GB)

(21) Appl. No.: 13/774,393

(22) Filed: Feb. 22, 2013

(30) Foreign Application Priority Data
Feb. 22, 2012 (GB) 1203041.7

(51) Int. Cl. F16K 51/00

(52) U.S. Cl. CPC F16K 51/00
USPC 137/343

(57) ABSTRACT

A liquid delivery system includes a portable tap stand connectable to a source of liquid, and a portable, collapsible liquid container shaped and dimensioned to allow the tap stand to stand therein during use. The tap stand includes a pipe having an inlet and multiple outlets, a respective tap being connected to each outlet. The tap stand further includes legs coupled to the pipe and configured to support the pipe in an upright position.

### RELATED APPLICATIONS

This application claims the benefit of priority of United Kingdom Application No. UK 1203041.7, filed Feb. 22, 2012, the content of which is incorporated by reference herein in its entirety.

### FIELD

The present invention relates generally to tap stands and systems employing same. The invention is particularly concerned with tap stands and water delivery systems suitable for rapid deployment in emergency situations.

### BACKGROUND

Tap stands are commonly used by, for example, aid agencies in the event of humanitarian emergencies to provide a means of distributing potable water. Conventional tap stands are supplied as a kit containing loose tubes, taps, fixings and assembly tools all provided in a wooden crate. Typically, concrete bases must be laid down for these products to mitigate problems with water loss in the area surrounding the tap stand. This requires time and skill to put into place, factors which are not always available in the aftermath of a disaster, as well as adding to the cost of installation. Nevertheless, wastage and spillage of water from the tap stand remains a problem. In addition, the wooden crates are not filled to capacity by the components, and thus important volume is wasted, therefore increasing transport costs. The tubes are typically galvanised steel, and therefore very heavy, which also contributes to transport and storage costs. Once installed, the tap stand cannot easily be relocated or otherwise re-used.

It would be desirable to provide a tap stand and tap stand system that mitigate the problems outlined above.

### SUMMARY

Accordingly, a first aspect of the invention provides a tap stand comprising a pipe having an inlet and at least one outlet, a respective tap being in liquid communication with said at least one outlet, wherein said tap stand further includes at least one leg coupled to the pipe and configured to support said pipe in a substantially upright position. Advantageously, said at least one leg is coupled to the pipe such that it is movable into and out of a deployed state in which said at least one leg supports said pipe in a substantially upright position.

Preferably, said tap stand comprises a plurality of deployable legs. The legs may be provided on a leg assembly coupled to the pipe, e.g. by means of one or more slidable collars, the assembly optionally including a linkage mechanism interlinking the legs for simultaneous deployment. Alternatively, the legs may be individually coupled to the pipe and individually deployable. The or each leg is preferably pivotably coupled to the pipe, preferably by means of at least one slidable collar. Typically the tap stand includes means for securing the or each leg in its deployed state (individually or collectively).

In preferred embodiments, the or each leg is movable between said deployed state and a stowed, or folded, state in which the or each is folded substantially against the pipe and/or, where there is more than one leg, the legs are folded substantially together. Optionally, the or each leg is removably coupled to the pipe.

Preferably, the or each tap is connected to a respective outlet by a flexible hose. The or each tap is preferably self closing. The or each tap may comprise a liquid-pouring type tap, a multi-aperture spray or sprinkler type tap, e.g. a shower head, or any other type of tap.

Advantageously, the tap stand includes a plurality of outlets, typically provided by a manifold. The outlets are preferably radially spaced apart around the pipe, and are preferably located at the in-use upper end of the pipe. Conveniently, the or each outlet, and when present the manifold, is located at an in-use upper end of the pipe. The inlet is typically located at an in-use lower end of the pipe.

A second aspect of the invention provides a liquid delivery system, and in particular a water delivery system, comprising a tap stand connectable to a source of liquid, especially water. The system is advantageously provided as a kit of parts.

Advantageously, the tap stand comprises a tap stand embodying the first aspect of the invention.

The liquid source typically comprises a liquid container, preferably a collapsible liquid container.

Preferably, the system includes a liquid containment bund (also known as a berm or drip tray) shaped and dimensioned to allow the tap stand, and optionally one or more water collection containers, to stand therein during use. The liquid containment bund is preferably collapsible.

The preferred system includes a waste liquid container connectable to the containment bund to receive liquid therefrom. The waste liquid container is preferably a self-supporting structure and, advantageously, is shaped and dimensioned to store at least said tap stand (when in a stowed state) and preferably also said containment bund (when collapsed) and/or said liquid container (when collapsed).

Advantageously, the tap stand is foldable between a deployed and non-deployed state and as such may be deployed rapidly, typically in seconds. Assembly tools are not required for deployment of the preferred tap stand. The tap stand may be supplied alone, or as part of a kit for a tap stand system that provides emergency water distribution and which can typically be assembled in minutes. The preferred tap stand system is supplied in a packaging container that is suitable for containing water, e.g. rotomoulded, and which forms part of the preferred system as said waste liquid container.

The preferred system includes said containment bund in which the tap stand sits thus eliminating the need to build concrete structures to collect spilled water, and typically also to serve as a foundation.

Skilled labourers are not required to set up the system and no tools are required for assembly. The systems is therefore relatively inexpensive, simple and quick to install, relatively simple and inexpensive to store and transport, and can readily be relocated for re-use. A pre-plumbed watertight system is factory assured.

Embodiments of the invention are volume and weight efficient, and so will help to reduce freight costs for, for example, aid relief agencies who spend heavily on emergency logistics.

Further advantageous aspects of the invention will become apparent to those ordinarily skilled in the art upon review of the following description of a specific embodiment and with reference to the accompanying drawings in which:

### BRIEF DESCRIPTION OF THE DRAWINGS

Embodiments of the invention are now described by way of example and with reference to the accompanying drawings in which like numerals are used to denote like parts and in which:

FIG. 1 is a perspective view of a water delivery system embodying one aspect of the invention and including a tap stand embodying a second aspect of the invention;

FIG. 2 is a perspective view of the tap stand of FIG. 1; and

FIG. 3 is a perspective view of an alternative embodiment of the tap stand, located in an alternative bund.

### DETAILED DESCRIPTION

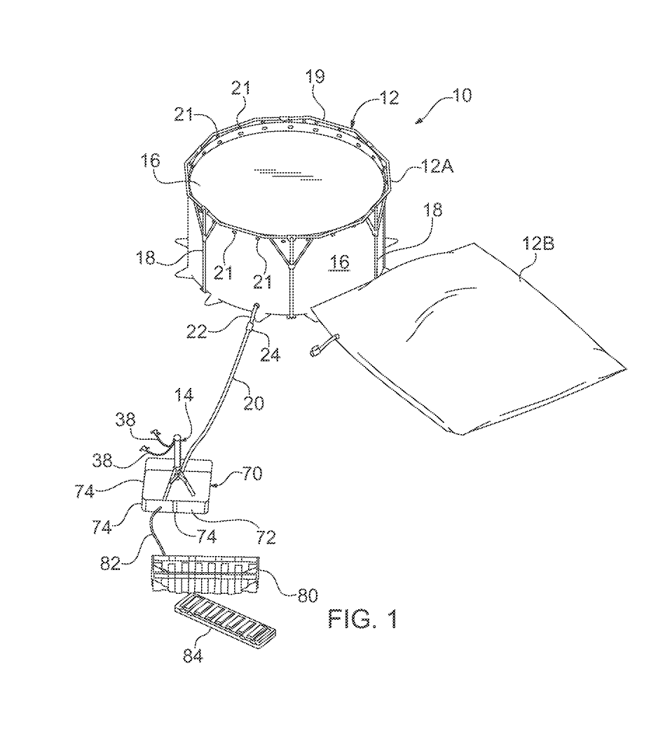

Referring now to FIG. 1 of the drawings there is shown, generally indicated as 10, a liquid delivery system, or tap stand system, embodying one aspect of the invention. The system 10 comprises a liquid storage container 12 connectable to a tap stand 14 for the delivery of, in particular, water thereto during use.

The container 12 may take any suitable form but is preferably of a type that is deployable between a non-use state and a use state, e.g. collapsible. In the non-use state the container 12 is typically folded and/or disassembled so that it is relatively small and suitable for transport or storage, i.e. a portable tap stand. FIG. 1 shows one example of the container 12 in the form of a tank 12A comprising a liquid receptacle 16 supported by a frame 18. The liquid receptacle 16 is formed from a flexible, liquid tight material, e.g. PVC coated fabric, that is capable of being folded when the receptacle 16 is not in use. The frame 18 comprises a kit of rigid frame members, typically formed from metal, e.g. aluminium, that can be assembled to form the frame 18 for supporting the receptacle 16 in its use state and disassembled for storage and/or transport. In preferred embodiments, the frame 18 includes an upper rim portion 19 from which the receptacle 16 is suspended by one or more resilient stretchable ties 21. Storage containers provided by Fast Engineering Limited of Greystone Road, Antrim, Northern Ireland United Kingdom under the brand FASTANK are suitable for use as the container 12. FIG. 1 shows an alternative liquid storage container in the form of a pillow tank 12B, which comprises a bag-like enclosure formed from flexible material, e.g. PVC coated fabric. Alternatively still, the container 12 may comprise a vehicle-mounted tank, a floating collar tank (or onion tank), a permanent (e.g. non-portable) tank, a reservoir or a well. In a further alternative, the tap stand may be connected to an alternative source of water, e.g. a water supply system. Where necessary, water stored in the container 12 may be treated against contamination in any conventional manner. In typical embodiments, the container 12 is raised with respect to the tap stand 14 to create a head of water (typically of at least 1 metre) to provide sufficient pressure to deliver water to the tap stand 14 and to allow it to be dispensed by the tap stand 14. Alternatively, a pump (not shown) may be connected to the system, e.g. in the container or between the container and the tap stand, to pump water to the tap stand.

Conveniently, the container 12 is connected to the tap stand 14 by a fluid delivery line 20, which may take any suitable form, e.g. hose or pipe, but is preferably flexible to allow it to be wound or otherwise folded for transport or storage. One end of the line 20 is connectable to an outlet 22 of the container 12 preferably by means of a quick-release connector 24. In preferred embodiments, a valve (not shown) is provided at the outlet 22, the valve being operable (e.g. in response to whether or not said line 20 was connected to the outlet 22, or manually) to selectably close the outlet 22. Alternatively the tap stand 14 may be connected directly to the outlet 22.

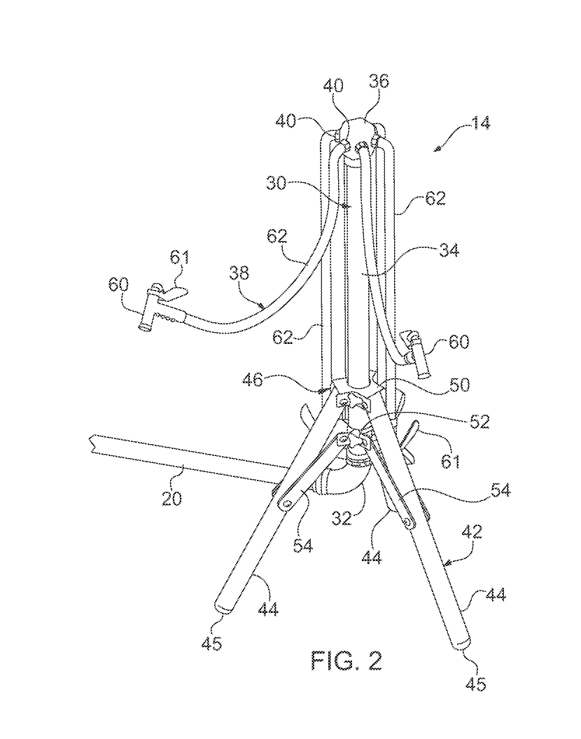

Referring in particular to FIG. 2, the tap stand 14 comprises a pipe 30 that is connectable to the container 12 for receiving water therefrom. The preferred pipe 30 has a substantially straight, rigid body 34. In the illustrated embodiment, the in-use lower end 32 of the pipe 30 provides an inlet for receiving water. The end 32 may be connected to the other end of line 20 by any convenient connector, preferably a quick-release connector to allow water to be delivered into the pipe 30 from the line 20. Conveniently, end 32 comprises a curved pipe section connected to body 34. The end section 32 may be curved with respect to the body 34 such that the inlet faces laterally during use to facilitate connection to the line 20 or outlet 22. In alternative embodiments, the water inlet may be located elsewhere in the pipe 30. Alternatively still, the pipe 30 may serve as a sleeve for receiving the line 20. For example, instead of being connected to end 32 to deliver water into the pipe 30, the line 20 may enter the pipe 30 at its inlet (at end 32 in this example) and be fed along the inside of the pipe 30, the outlet of the line 20 being in liquid communication with the or each outlet of the tap stand or pipe. The line 20 may extend partly or fully along the length of the pipe body 34. Depending on the arrangement, the inside of the pipe may or may not come into direct contact with the liquid being dispensed.

The preferred tap stand 14 includes a manifold 36 for distributing water to a plurality of outlet devices 38. The manifold 36 conveniently comprises a cap located at the in-use upper end of the pipe 30. The manifold 36 may comprise a hollow body in which the outlets are formed, and/or a body in which respective channels are formed for directing water between the pipe 30 and a respective outlet 40. In the illustrated embodiment, the manifold 36 and inlet 32 are provided at opposite ends of the body 34. The manifold 36 has a respective outlet 40 for supplying water to each outlet device 38, the outlets 40 preferably being radially spaced around the manifold. The manifold 36 provides fluid communication between the pipe 30 and the outlet devices 38 (or between the line 20 and the outlet devices in the case where the pipe 30 is used only as a sleeve for the line 20) via the respective outlets 40, preferably without intermediate valves. The outlets 40 may be of substantially the same size so that substantially equal amounts of water are supplied to the respective outlet devices 38 during use. The manifold 36 may be removably fitted to the pipe 30 by any convenient connection means, e.g. screw fittings, a push-fit connection or a quick-release connector and/or by sealing using an o-ring or similar device. In alternative embodiments, the tap stand may have only one outlet device, in which case the manifold is not required and the pipe may have a single outlet, preferably at its in-use upper end.

When the tap stand 14 is deployed, the pipe 30, and in particular the body 34, is substantially upright, i.e. substantially perpendicularly disposed with respect to the ground surface. In this position, the end 32 of pipe 30 is preferably held substantially at ground level or above ground level. To support the pipe 30 in this position, the tap stand 14 includes at least one deployable leg, typically a plurality of deployable legs. In the preferred embodiment, the tap stand 14 includes a leg assembly 42 comprising multiple legs 44 interlinked by a linkage mechanism 46 configured to allow the legs 44 to be operated simultaneously between a deployed state (as illustrated) in which they support the pipe 30 in its upright position, and a stowed state (not illustrated) in which they are folded for ease of transport or storage. The leg assembly 42 may coupled to the pipe 30 using any convenient coupling. In the preferred embodiment, the assembly 42 remains coupled to the pipe 30 in both the deployed and stowed states, although in alternative embodiments, the assembly 42 may be removable from the pipe 30. The legs may take any convenient form, e.g. circular or rectangular in cross section, hollow or solid. Preferably, each leg is provided with a resiliently deformable foot 45, for example made of rubber. Optionally, one or more of the legs may be extendible, e.g. telescopically extendible.

In the preferred embodiment, the linkage mechanism 46 comprises upper and lower collars 50, 52 located around the body 34. The in-use upper end of each leg 44 is pivotably coupled to the upper collar 50. A respective linkage 54 has one end pivotably coupled to the lower collar 52 and the other end pivotably coupled to the respective leg 44, preferably at a location between its ends. During at least deployment and optionally stowage of the legs 44, one or other of the collars 50, 52 is fixed with respect to the pipe 30 (by any convenient fixing device(s), e.g. one or more screws or clamps or interference fit mechanisms), the other collar 52, 50 being slidable along the pipe 30. To operate the assembly 42 from the deployed state to the stowed state, a user may push any one of the legs 44 inwardly towards the pipe 30, causing the slidable collar 52, 50 to move along the pipe towards the fixed collar 50, 52 and causing the other legs 44 to simultaneously fold in towards the pipe 30. In the preferred embodiment, the legs 44 are folded substantially against the pipe 30 in the stowed state, a run substantially parallel with the body 34 of the pipe 30. To operate the assembly 42 from the stowed state to the deployed state, a user may pull any one of the legs 44 outwardly from the pipe 30, causing the slidable collar 52, 50 to move along the pipe away from the fixed collar 50, 52 and causing the other legs 44 to simultaneously fold outwardly from the pipe 30. The slidable collar 52, 50 may be provided with fixing device(s), e.g. one or more screws or clamps or interference fit mechanisms, for releasably securing the collar 52, 50 with respect to the pipe 30 in order to retain the assembly 42 in the deployed or stowed state. The fixing device(s) use to secure the fixed collar 50, 52 with respect to the pipe 30 is preferably releasable to allow the collar 50, 52 to slide with respect to the pipe. This allows the leg assembly 42 to slide along the pipe 30, which can reduce the length of the tap stand 14 when stowed, or to be removed from the pipe 30. In preferred embodiments, the collar 52 is the fixed collar and the collar 50 is the slidable collar.

In the illustrated example, the tap stand 14 has three legs 44, but it will be understood that more or fewer legs may be provided in alternative embodiments. In alternative embodiments, the leg(s) may be individually deployable and stowable. For example, the lower collar 52 and links 54 may be omitted. Each leg 44 may be provided with means for fixing it at least in its deployed state and preferably also in its stowed state. For example, the fixing means may comprise a friction-hold coupling (e.g. between the leg and the collar or the leg and the pipe), a screw-tightenable coupling (e.g. between the leg and the collar or the leg and the pipe) or a releasable latching mechanism.

The preferred outlet devices 38 comprise a tap 60 in fluid communication with a respective outlet 40, preferably by means of a respective fluid delivery line 62. Alternatively, the taps 60 may be connected directly to the outlets 40. In the preferred embodiment, at least some or and preferably each fluid delivery line 62 comprises a flexible hose. The outlet devices 38 may be permanently connected to the outlets 40 by any convenient means, or may be releasably coupled thereto by any suitable means for removal during storage and transport (e.g. a self-sealing plug in fitting or quick release coupler). The taps 60 are preferably self-closing, i.e. configured to adopt a closed state when not being actively opened by a user. The taps 60 may comprise a liquid-pouring type tap, a multi-aperture spray head or sprinkler type tap, or any other type of tap, typically being operable by a common or respective user control mechanism (lever 61 in the illustrated example). Where the tap stand includes multiple taps, the taps need not necessarily be of the same type.

The preferred system 10 also includes a second liquid container 70, referred to herein as a containment bund (also known as a berm or drip tray). The bund 70 is preferably of a type that is deployable between a non-use state and a use state, e.g. collapsible. In the non-use state the bund 70 is typically folded and/or disassembled so that it is relatively small and suitable for transport or storage. FIG. 1 shows one example of the bund 70 comprising a liquid receptacle 72 and support members 74. The liquid receptacle 72 is formed from a flexible, liquid tight material, e.g. PVC coated fabric, that is capable of being folded when not in use. The supports 74 may comprise a kit of rigid frame members, typically formed from metal, e.g. aluminium, that can be assembled to form the supports 74 for supporting the receptacle 72 in its use state and disassembled for storage and/or transport. Storage containers provided by Fast Engineering Limited of Windmill Court, Antrim, Northern Ireland, United Kingdom under the brand FASTANK BUND are suitable for use as the containment bund 70. In use, the tap stand 14 stands in the bund 70. Any water dripping from or spilled during use of the tap stand 14 is collected by the bund 70.

The preferred system 10 further includes a third liquid container 80 connectable to the bund 70 for receiving water therefrom during use. Conveniently, the container 80 is connected to the bund 70 by a fluid drainage line 82, which may take any suitable form, e.g. hose or pipe, but is preferably flexible to allow it to be wound or otherwise folded for transport or storage. One end of the line 82 is connectable to an outlet from the bund 70 by any convenient connection means, the other end being connectable to the container 80 by any convenient connection means, or otherwise coupled to the container 80 so that it can deliver water thereto, e.g. placed in or over the container 80. The fluid connection between the container 80 and bund 70 is conveniently an open one so that fluid may flow freely from the bund 70 to the container 80, although a check valve may be provided to prevent liquid from flowing back to the bund 70. Typically, the container 80 is positioned in use at a level below that of the bund 70. Optionally, a pump (not shown) may be provided for pumping the water from the bund 70 to the container 80.

Advantageously, the container 80 doubles as packaging for the system 10 when not in use, e.g. during storage or transport. To this end, it is preferred that the container 80 comprises a rigid, self-supporting structure, e.g. formed from rigid or semi-rigid plastics, by, for example, rotomoulding. The container 80 is shaped and dimensioned to receive the tap stand 14, as well as the bund 70 (when present), container 12 (when present), all in their stowed or folded states, together with any fluid lines 20, 82 and accessories. The container 80 preferably has a removable lid 84. Advantageously, the lid 84 is shaped and dimensioned, or is otherwise adaptable, for use as a stretcher or other load carrier.

During use of the preferred embodiment, water is delivered to the tap stand 14 from the container 12 via hose 20 under pressure caused by the head of water in the container 12. The water enters the pipe 30 via the inlet at end 32 and is forced up the pipe 30 to the manifold 36, whereupon it is distributed to the outlet devices 38 via the respective outlets 40. When a taps 60 are opened, water is dispensed under the head pressure. The flexible hoses 62 make the taps more amenable to use by a user (e.g. when filling a container) and help to reduce the amount of spillage. By gathering spilled or leaked water, the bund 70 prevents the surrounding ground from becoming muddy and so reduces the chance of disease and infection occurring. Waste water collected in the bund 60 is drained to the container 80. The water collected in the container 80 may be disposed of in any convenient manner (preferably put to practical use e.g. watering crops), or the container may be used as a trough, e.g. for animals or washing.

Optionally, more than one tap stand may be connected to the container 12, or other water source, during use. To this end the container 12 or other water source may have multiple outlets.

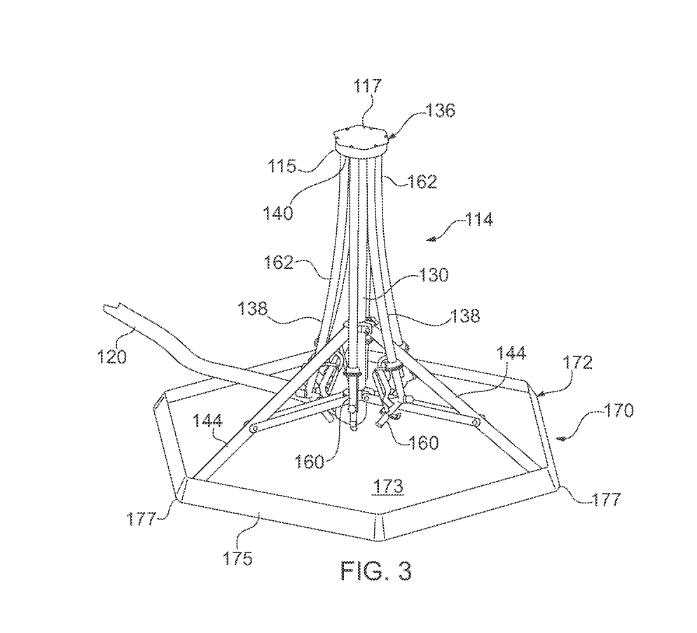

Referring now to FIG. 3 of the drawings, there is shown an alternative embodiment of a tap stand, generally indicated as 114, shown in an alternative embodiment of the liquid container, or bund 170. Unless stated otherwise or apparent from the drawings, the tap stand 114 and bund 170 are similar to the tap stand 14 and bund 70 hereinbefore described and so similar numerals are used to denote like parts and the same or similar description applies, as would be apparent to a skilled person. The tap stand 114 and bund 170 are each (individually or together) suitable for use as part of the water delivery system 10, or other embodiments of the water delivery system.

The manifold 136 of the tap stand 114 comprises a body 115 with a removable cover 117. The removable cover 117 provides access to the inside of the body 115 should repair or maintenance be required. The outlets 140 for connection to the delivery lines 162 are provided in an in-use underside of the body 115, preferably in a side or face of the body 115 that is opposite to the removable cover 117. As a result, the delivery lines 162, each of which typically comprises a hose, extend or hand downwardly in use from the underside of the body 115 without having to bend. In comparison with the embodiment of FIGS. 1 and 2, this reduces the strain on the connection between the line 162 and the outlet 140, as well as protecting the connections especially during transit. It is also helps to reduce restrictions or blockages in the line 162 that can occur as a result of kinks. In the preferred embodiment the body 115 has a face (not visible) which extends around the pipe 130 and faces the ground during use, in which face the outlets 140 are provided.

The liquid container 170, or bund, comprises a liquid receptacle 172 formed from a liquid impermeable material, e.g. PVC coated fabric, that is non-resilient and flexible, or otherwise susceptible of being folded away when not in use. The receptacle 172 is shaped to have a base 173 surrounded by a wall 175. The receptacle 172 is dimensioned with respect to the tap stand 14, 114 such that the tap stand 14, 114, when located in the bund 170, supports the receptacle, especially the wall 175, to maintain the wall 175 substantially upright and so to maintain the receptacle 172 in a shape in which it can hold liquid. In the illustrated embodiment, the legs 44, 144 engage with the wall 175 to this end. The feet (not visible) at the end of the legs 44, 144 may engage with the interface between the base 173 and wall 175 at respective locations. The receptacle 172 may be shaped to define a respective foot-receiving corner or socket 177 for each leg 44, 144 of the tap stand. Hence, separate support structures are not required to maintain the bund 170 in the desired shape.

It is preferred that the outlet devices 138 are arranged such that the dispensing ends of the taps 160 face inwardly of the tap stand, i.e. generally towards the pipe 130.

It is found that typical systems embodying the invention are smaller (when stowed) and lighter when compared to conventional systems. This saves significantly in transport costs. The tap stand can be carried by one person to a site (and so is suitable for use in emergencies where logistics are an issue—e.g. destroyed roads due to earthquake). Disease and infection are controlled by water capture in the bund and by distancing the main water source from both the tap stand and the container 80. The preferred system 10 is largely fold-out, so it is less likely that parts can be lost or separated in transit. The preferred system may be deployed rapidly with no site preparation required and without tools or skilled labour. It is suitable for rapid relocation, or for expansion. Alternative embodiments may however be permanently installed. Conservation of spilled water means that water which has typically been freighted to site is not wasted but made useful for washing clothes, watering animals, washing, crop watering etc.

Although the invention is described herein in the context of a water delivery system, it will be understood that the invention is not limited to use with water and may be used with other liquids and for applications other than emergency humanitarian relief.

The invention is not limited to the embodiments described herein which may be modified or varied without departing from the scope of the invention.

What is claimed:

1. A tap stand comprising a pipe having an inlet and at least one outlet, a respective tap being in liquid communication with said at least one outlet, wherein said tap stand further includes at least one leg coupled to the pipe and configured to support said pipe in a substantially upright position.

2. A tap stand as claimed in claim 1, wherein said respective tap is connected to a respective outlet by a flexible hose.

3. A tap stand as claimed in claim 1, wherein said at least one leg is coupled to the pipe such that it is movable into and out of a deployed state in which said at least one leg supports said pipe in a substantially upright position.

4. A tap stand as claimed in claim 1, wherein, said at least one leg comprises a plurality of deployable legs.

5. A tap stand as claimed in claim 1, wherein said at least one leg is provided on a leg assembly coupled to the pipe.

6. A tap stand as claimed in claim 5, wherein said leg assembly is coupled to said pipe by at least one slidable collar.

7. A tap stand as claimed in claim 5, wherein said at least one leg comprises a plurality of deployable legs, and said leg assembly comprises a linkage mechanism interlinking said legs for simultaneous deployment.

8. A tap stand as claimed in claim 1, wherein said at least one leg is individually coupled to the pipe and individually deployable.

9. A tap stand as claimed in claim 1, wherein said at least one leg is pivotably coupled to the pipe.

10. A tap stand as claimed in claim 1, further including securing means for securing said at least one leg in its deployed state.

11. A tap stand as claimed in claim 1, wherein said at least one leg is movable between said deployed state and a stowed state in which the or each is folded substantially against the pipe

12. A tap stand as claimed in claim 1, wherein said at least one leg comprises a plurality of legs, the legs being folded substantially together in a stowed state.

13. A tap stand as claimed in claim 1, wherein said respective tap comprises any one of a liquid-pouring tap, a multi-aperture spray, sprinkler tap, a shower head, or a spray nozzle.

14. A tap stand as claimed in claim 1, wherein said at least one outlet comprises a plurality of outlets provided by a manifold connected to said pipe.

15. A tap stand as claimed in claim 14, wherein said outlets are radially spaced apart around the pipe.

16. A tap stand as claimed in claim 14, wherein said outlets are located in an underside of said manifold.

17. A tap stand as claimed in claim 14, wherein said manifold is located at the in-use upper end of the pipe.

18. A tap stand as claimed in claim 1, wherein said inlet is located at an in-use lower end of the pipe.

19. A tap stand as claimed in claim 1, wherein said manifold comprises a body having a removable cover.

20. A liquid delivery system comprising a portable tap stand connectable to a source of liquid, and a portable, collapsible liquid container shaped and dimensioned to allow said tap stand to stand therein during use.

21. A system as claimed in claim 20, wherein said tap stand comprises a pipe having an inlet and at least one outlet, a respective tap being in liquid communication with said at least one outlet, wherein said tap stand further includes at least one leg coupled to the pipe and configured to support said pipe in a substantially upright position.

22. A system as claimed in claim 20, wherein said liquid source typically comprises a source liquid container, preferably a portable, collapsible liquid container.

23. A system as claimed in claim 20, further including a waste liquid container connectable to the liquid container to receive liquid therefrom.

24. A system as claimed in claim 23, wherein said waste liquid container comprises a self-supporting structure and is shaped and dimensioned to store at least said tap stand when in a stowed state.

25. A system as claimed in claim 23, wherein said waste liquid container is shaped and dimensioned to store said liquid container when collapsed and/or said source liquid container when collapsed.
